(19) United States
(12) Patent Application Publication
(10) Pub. No.: US 2025/0224321 A1
(43) Pub. Date: Jul. 10, 2025

(54) GUIDE BEARING WITH MULTIPLE PRESSURE MEASUREMENT POINTS, SYSTEM FOR MEASURING THE VISCOSITY OR REYNOLDS NUMBER OF A FLUID, WITH A POLE GUIDED BY THE BEARING, APPLICATION TO MONITORING IN BIOPRODUCTION

(71) Applicant: COMMISSARIAT A L'ENERGIE ATOMIQUE ET AUX ENERGIES ALTERNATIVES, Paris (FR)

(72) Inventors: Elisabeth Delevoye, Grenoble Cedex (FR); Tristan Caroff, Grenoble (FR); Vincent Elhorga, Grenoble (FR)

(21) Appl. No.: 19/011,078

(22) Filed: Jan. 6, 2025

(30) Foreign Application Priority Data
Jan. 8, 2024 (FR) 2400143

(51) Int. Cl. G01N 11/10; F16C 29/04

(52) U.S. Cl. CPC G01N 11/10; F16C 29/04

(57) ABSTRACT

Guide bearing with multiple pressure measurement points, System for measuring the viscosity or the Reynolds number of a fluid, with a rod guided by the bearing, Application to monitoring in bio-production. A guide bearing of central axis (X), including a ring, intended to be mounted tightly in a holding structure, the inner surface of which is designed for assembling with a clearance fit, and preferably guiding in translation along the axis X, a tube intended to constitute a measurement rod; an angulation element formed integrally or fixed inside the inner surface of the ring by protruding into it, so as to form an angulation axis of the tube relative to the axis X; a plurality of pressure sensors each designed to measure a point of pressure exerted by a contact point of the tube in one of its angular positions, the pressure sensors being distributed along the inner surface of the ring, on either side of the angulation element.

### TECHNICAL FIELD

The present invention relates to the field of pressure measuring instruments, more particularly those dedicated to knowing the state of a fluid.

It notably aims to provide a reliable, precise and rapid solution for measuring the viscosity and/or the Reynolds number of a fluid within a bioreactor.

Although it is described with reference to this measurement application, the invention can be envisaged for any application for measuring the state of a fluid (liquid, gas) within a vessel such as a tank, more particularly one with opaque walls, the conditions of use of which set the fluid in global or local movement. It can for example be a production or settling tank.

In the case of a fluid agitated within the tank, the invention can be utilized to optimize the effectiveness of the agitation, notably to adapt the speed, the height and/or the type of the turbine agitator.

### BACKGROUND

Stirred-tank reactors, such as bioreactors, are widely used in numerous fields in the chemical industry.

In the field of bio-production, it is not possible to prepare biological products that are living substances (vaccines, micro-algae, bio-pharmaceutical molecules, etc.) within bioreactors by a completely pre-defined protocol.

This is because this preparation requires a permanent adaptation to adjust the physical parameters of the fluid, such as its viscosity, its agitation speed, its temperature, and its bubble content, gas content, nutrient content, etc. on the basis of imperfect measured parameters, which consist of biochemical measurements that are indirect, such as the pH, and/or are applicable only locally and/or are incomplete, etc.

Investigating the flow of fluid in a bioreactor is indispensable, in order to provide key information for the choice of the best adaptation to make in real time. In particular, the viscosity and, by correlation, the Reynolds number, which defines the nature of a flow as a function of its speed and also of the viscosity of the medium which is flowing, is an essential parameter to know.

When the tanks of the reactors have transparent walls, it is possible to measure the state of a fluid using means of measurement by indirect observation from the outside. These means may be optical means, such as lasers, high-speed cameras, or even visual observations, etc.

However, a good number of bioreactors have a tank with opaque walls so as to not allow penetration of a luminous flux or for equipment cost or robustness reasons. This therefore de facto rules out the aforementioned indirect measurement means.

In addition, it is generally impossible or prohibited for use to be made in bioreactors of measurement capsules which move freely with the permanent or intermittent movements of the fluid.

There is therefore a need to find a reliable and precise measurement solution for measuring the state of a fluid, notably its viscosity and/or its Reynolds number, within a bioreactor, notably one with opaque walls.

More generally, there is a need to find a reliable, precise and rapid measurement solution for measuring the state of a fluid (liquid, gas), irrespective of whether it is moving or not within a tank, notably a settling or production tank.

The aim of the invention is to at least partially meet this (these) need(s).

### SUMMARY OF THE INVENTION

To this end, the invention relates to a guide bearing of central axis (X), comprising:
a ring, intended to be mounted tightly in a holding structure, the inner surface of which is designed for assembling with a clearance fit, and preferably guiding in translation along the axis X, a tube intended to constitute a measurement rod;
an angulation element formed integrally or fixed inside the inner surface of the ring by protruding into it, so as to form an angulation axis of the tube relative to the axis X;
a plurality of pressure sensors connected to one another and each designed to measure a point of pressure exerted by a contact point of the tube in one of its angular positions, the pressure sensors being distributed along the inner surface of the ring, on either side of the angulation element.

A tank can be equipped with one or more tubes, for example to set up the means for agitating the fluid, or a means for introducing nutrients or a gas, or any other functions. In general, the rods are fixed but some may be rotatable or translatable and actuated by motors. A rod may be equipped with one or more measuring probes, notably a probe able to take electrochemical measurements.

The invention proposes the use of any one of these types of rods to take the measurements according to the invention, to which end this rod is referred to as measurement rod.

The angulation element is a mechanical element that allows swivelling.

Advantageously, the angulation element is an O ring.

According to an advantageous embodiment variant, the pressure sensors are distributed in an equal number on either side of the angulation element.

According to another advantageous embodiment variant, the pressure sensors are received individually or in groups in cavities in the inner surface of the ring and each comprise a protuberance designed to be in contact with the contact point of the tube.

According to a first configuration alternative, the pressure sensors are aligned along one or more straight lines parallel to the central axis (X).

According to a second alternative, the pressure sensors are arranged along a surface, such that during an angulation of the tube, the pressure sensors come into contact with the tube separately, one after another.

According to a third alternative, the pressure sensors are arranged along a surface, such that during an angulation of the tube, the pressure sensors come into contact with the tube one after another, cumulating the pressure that they detect.

Advantageously, there are four pressure sensors, coupled in pairs, for each diameter of the ring inner surface over which they are distributed.

According to an advantageous embodiment, the guide bearing comprises at least one conical or cylindrical ball-and-cage assembly intended to hold the tube, the ball-and-cage assembly being mounted by being held inside the ring with a portion without balls in contact with the angulation element and at least one portion of the balls each forming the point of contact with a pressure sensor arranged in the inner surface of the ring.

According to an advantageous embodiment, the guide bearing comprises at least one sleeve mounted by being held inside the ring, the sleeve comprising:
protuberances each forming the point of contact with a pressure sensor arranged in the inner surface of the ring, and/or
at least one portion of the pressure sensors distributed along its outer surface.

With preference, the pressure sensors are piezoelectric sensors.

The invention also relates to a system for measuring the viscosity or the Reynolds number of a fluid contained in a vessel, such as a tank, notably one with opaque walls, comprising:
at least one guide bearing as described above, mounted tightly in a wall of the vessel,
a measurement rod which forms the tube, is assembled by way of a clearance fit in the ring of the guide bearing, and one, free end of which is intended to be immersed in the fluid,
at least one means for fixing the other end of the measurement rod, the means being designed to limit the angulation of the measurement rod in the ring.

According to an advantageous embodiment, the system comprises a sleeve forming an adapter of diameter in which the measurement rod is mounted tightly and which is assembled by way of a clearance fit with the ring.

According to this embodiment, the adapter of diameter preferably comprises, on its outer surface, a plurality of protuberances each forming the point of contact with a pressure sensor arranged in the inner surface of the ring.

With preference, the electrochemical sensor is fixed at the free end of the measurement rod.

The invention also relates to a settling or production tank, notably of a bioreactor, comprising a system as described above.

The invention also relates to the use of a measuring system as described above or of a bioreactor as described above for monitoring a bio-production.

The invention therefore essentially consists of a guide bearing comprising a ring in which a measurement rod is mounted with a clearance fit, the bearing incorporating an angulation element for the measurement rod within the ring.

The angulation element makes it possible to establish an angulating contact, or in other words a pivoting contact, of the measurement rod so as to stabilize the relative movements with respect to the ring and to distribute, on either side of said contact, the forces to which the rod is subjected when it is immersed in a fluid of which the viscosity or the Reynolds number is to be measured.

The bearing is instrumented by multiple pressure sensors distributed along the inner surface of the ring, which will measure various pressures of the rod when it takes angular positions depending on the pressure of the fluid applied to the free end of the rod.

The pressure sensors are advantageously distributed so as to distribute them in an equal number on either side of the angulation element. This distribution makes it possible to make the pressure measurements symmetrical with respect to the angulating contact and therefore enables averaged or differential measurements.

The pressure sensors are connected to one another, advantageously in the form of a matrix of rows and columns or a network configuration referred to as “daisy chain”, by forming a connection linked to an (analogue or digital) electronic reading means monitored by scanning.

The sensors can be standard provided that they are precise and have a small space requirement. For example, the sensors sold by Wormsensing (https://www.wormsensing.com/) can be implemented both for rings of large size or smaller size, adapted to measurement rods of small diameter.

For each case of use, which is to say of a given fluid under certain conditions, it is possible to define a law which links the position of each point of contact of a measurement rod with a pressure sensor to the angulation of the rod. Since the maximum angle of the rod is constrained by an ad hoc fixing means, for example a gimbal joint and/or a radial end stop, it provides information about the overall pressure to which the rod is subjected.

Thus, the spatialization of the measurement of pressures inside a guide bearing of a measurement rod makes it possible to analyse the state of pressure of a fluid in which the rod, which is at a distance from the bearing, is immersed.

For the analysis per se, an interpolation method can be implemented.

It is also possible to implement an artificial intelligence classification method to determine and discriminate the various states of pressure that are accumulated and mingled in the measured data. The classes created can be realized as a function mainly of two measurement groups, specifically a group of several classes associated with a discretization of the average pressure levels and a group characterizing the rapid fluctuations in pressure around discrete pressure levels.

It is thus possible to determine the Reynolds regime and/or the level of viscosity of the fluid.

As a result of the analysis of the data measured by the guide bearing according to the invention, it is possible to dynamically manage, in real time, which is to say during the execution of an industrial process utilizing a fluid, the choice between several settings or several configurations of a system for regulating the conditions of the fluid, for example of an instrumentation and control system acting for example on a turbine agitator or on a bubbling system. This agitator can intervene notably owing to a considerable variation in the viscosity of the fluid or a lack of oxygenation.

This dynamic management can be implemented by means of a digital twin. As a function of the environmental variables supplied by the classification method according to the measurement data from the bearing according to the invention, the digital twin can carry out new simulations. These simulations can be realized for example by way of finite elements. The digital twin can also change the calculation model, for example by model order reduction (MOR), which is a technique for reducing the calculation complexity of the mathematical models in the digital simulations.

Ultimately, the invention affords numerous advantages, among which mention may be made of the following:
the definition of a law which links the pressure and the angulation of a measurement rod by definition of the contact points of the rod and the possible fabrication on demand of the associated surface of arrangement of the pressure sensors. The instrumented guide ring is sensitive to the contacts made by the rod, which exert compressive forces on the defined points, and is insensitive to the tensile forces and the tangential forces on these points. The ring is additionally intrinsically insensitive to the axial forces. This makes it possible to correlate the measured behaviour with the likewise radial forces to which the fluid is subjected on the measurement rod;
the determination of the order of magnitude of the pressures to which the measurement rod is subjected within a pressure range;
the determination of the regime of a flow of fluid around a measurement rod, defined by its Reynolds number and/or its viscosity;
the taking of precise measurements, even with a reduced space requirement or for vessels (tanks) containing the fluid to be measured that are not agitated or the agitation of which is non-turbulent. In such conditions, a change can be measured as an overall average pressure value and/or as a spatial distribution of the pressures taken by the sensors, which acts as an indicator for the state of the medium (static pressure becoming high, increased turbulence, etc.);
the option of estimating the three-dimensional pressure field of the fluid on the measurement rod and possibly, partially, around a part of the immersed rod. In the best configurations, the information collected is a direct and faithful reflection of the spatial distribution of the pressures applied by the fluid to the distant (and immersed) part of the measurement rod. In this case, it is necessary to realize beforehand a detailed digital simulation of the rod, of the fluid, of the interactions between the rod and the fluid by FSI (“Fluid-Structure-Interaction” or CFD (“Computational Fluid Dynamics”) calculations, of the instrumented guide bearing and notably of the specific arrangement of the surface of the sensors. The spatialized data make it possible to calibrate the spatial response on the surface of arrangement of the sensors within the ring, and this then makes it possible to define the three-dimensional pressure field of the fluid that generates this response;
the option of using the spatialized monitoring of the pressures measured by the bearing as a useful tool in a digital twin of the vessel, such as a tank, which contains the fluid in which the measurement rod is immersed.

Other advantages and features will become more clearly apparent on reading the detailed description, which is given by way of non-limiting illustration, with reference to the following figures.

### BRIEF DESCRIPTION OF THE DRAWINGS

FIG. 1 is a schematic view of the implementation of a rod of the measuring system for measuring the physical state of a fluid in a vessel, according to the invention.

FIG. 2 is a schematic view of a rod of the measuring system according to the invention with its angulation-limitation connecting means, of which the distal end has zero angulation and is possibly equipped with a motor for driving in translation or rotation.

FIG. 3 is a schematic view of a variant of FIG. 2.

FIG. 4 illustrates, in the form of a curve, the increase in the average angle of a measurement rod of which one part is immersed in a fluid which exerts a given level of pressure on said immersed part and the fluctuations around average levels originating from vibrations in the rod, which are caused by the fluctuations of the dynamic pressure in the liquid.

FIG. 5 is a view, in longitudinal section, of an instrumented guide bearing according to the invention with its guide ring in which a measurement rod is mounted with a clearance fit.

FIG. 6 is a view, in longitudinal section, of an advantageous embodiment of the guide bearing of which the inner surface of the ring has a profile designed to measure pressures for a given fluid.

FIG. 7 is a view, in longitudinal section, of a first advantageous embodiment variant of the guide bearing comprising a ball-and-cage assembly inside the guide ring.

FIG. 8 is a view, in longitudinal section, of another embodiment variant with the measurement rod mounted tightly in a measurement adapter, which is itself mounted with a clearance fit in the guide ring.

FIG. 9 is a view, in longitudinal section, of a second advantageous embodiment variant of the guide bearing comprising a sleeve with contact protuberances, inside the guide ring.

FIG. 10 is a view, in longitudinal section, of a third advantageous embodiment variant of the guide bearing comprising a sleeve, which is itself provided with pressure sensors, inside the guide ring.

FIG. 11 is a view, in longitudinal section, of another embodiment variant with a sleeve or adapter of diameter, of conical shape, inside the guide ring.

FIG. 12 is a view, in longitudinal section, of another embodiment variant with a cylindrical ball-and-cage assembly with balls of different diameters, inside the guide ring.

FIG. 13 is a view, in longitudinal section, of another embodiment variant with a conical ball-and-cage assembly with balls of different diameters, inside the guide ring.

FIG. 14 is a schematic view of another embodiment of a measuring system according to the invention.

### DETAILED DESCRIPTION

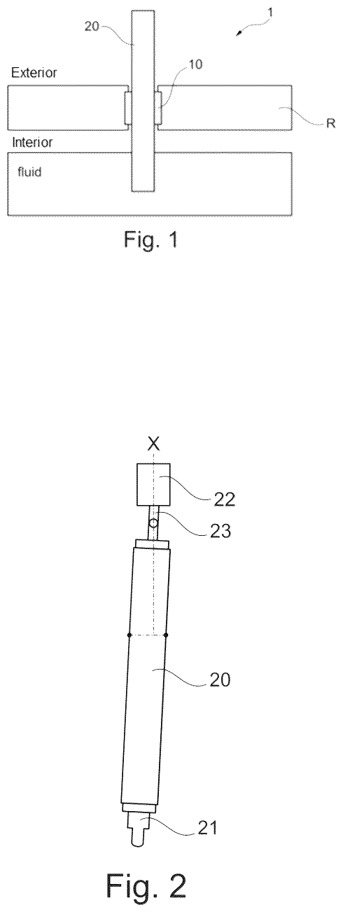

For the sake of clarity, the same references denoting the same elements according to the invention are used for all the FIGS. 1 to 14.

The drawings and the mutual arrangement of the various elements are not shown to scale.

Throughout the present application, the terms “above”, “below”, “lower” and “upper” are to be understood with reference to the measuring system according to the invention as in an installation configuration with the guide bearing arranged vertically.

FIG. 1 illustrates a measuring system 1 for measuring the viscosity or the Reynolds number of a fluid contained in a vessel R, such as a tank, notably one with opaque walls. It can be the tank of a bioreactor containing a bio-production fluid, the agitation conditions of which are to be known and managed.

The system 1 comprises a guide bearing 10, mounted tightly in a wall of the vessel R, which is instrumented by multiple pressure sensors distributed spatially along the bearing, as explained below. As illustrated, the bearing 10 may be mounted vertically in an upper wall, notably the cover of the vessel R.

A measurement rod 20 is assembled by way of a clearance fit in the guide bearing 10 to both enable guidance in translation and permit an angulation of the rod.

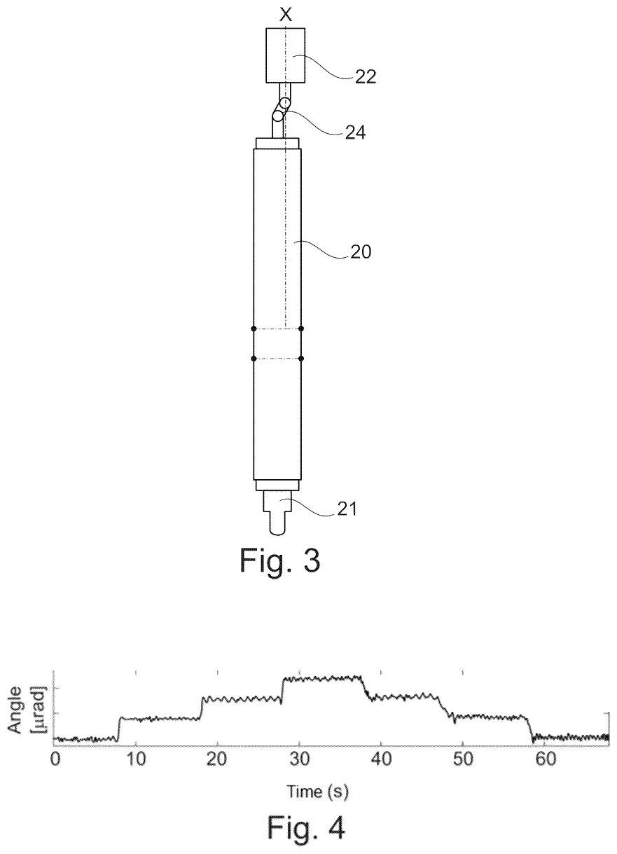

The lower, free end of the rod 20 is immersed in the fluid which is contained in the vessel R and the viscosity or the Reynolds number of which is to be measured. As illustrated in FIGS. 2 and 3, the lower end of the rod can support one or more electrochemical sensors 21 which serve to determine chemical properties of the fluid.

The upper end of the measurement rod is fixed by a fixing means which is designed to limit the angulation of the rod in the guide bearing 10.

This angulation limitation will make it possible to increase the pressure range of the fluid which will be able to be measured by the instrumented guide bearing 10.

Preferred rod fixing means are those that promote the translational movements of the rod 20 in the bearing 10 rather than the rotational movements at the fixing point.

If it is not desired to restrain the oscillation movements of the measurement rod, which is fixed or made movable by means of a drive motor, it is possible to implement gimbal fixing solutions.

Such a fixing example is shown in FIG. 2: the upper end of the rod 20 is connected to a motor 22 for driving in rotation, of axis coincident with the central axis X of the guide bearing 10, by way of a single gimbal 23.

One variant is illustrated in FIG. 3: the connection between the motor 22 and the rod 20 can be established by a double gimbal 24, which has the advantage of attenuating the pendulum movements of the rod in the fluid.

It is also possible to envisage other angulation limiting means, such as a radial end stop which can for example be installed directly in the wall in which the guide bearing 10 is mounted. On contact with the stop, the measurements according to the invention lose their meaning.

The curve in FIG. 4 illustrates on the one hand the increase in the average angle taken by a measurement rod 20 with a given level of pressure exerted on the immersed part of the rod, and on the other hand the fluctuations around the average levels originating from vibrations in the rod, which are caused by the fluctuations of the dynamic pressure in the fluid.

The assembly clearance between the guide bearing 10 and the measurement rod 20 makes it possible to amplify the measurable fluctuations around average levels and the pressure range of the fluid that can be measured by the instrumented guide bearing 10 with a spatialization of its pressure sensors.

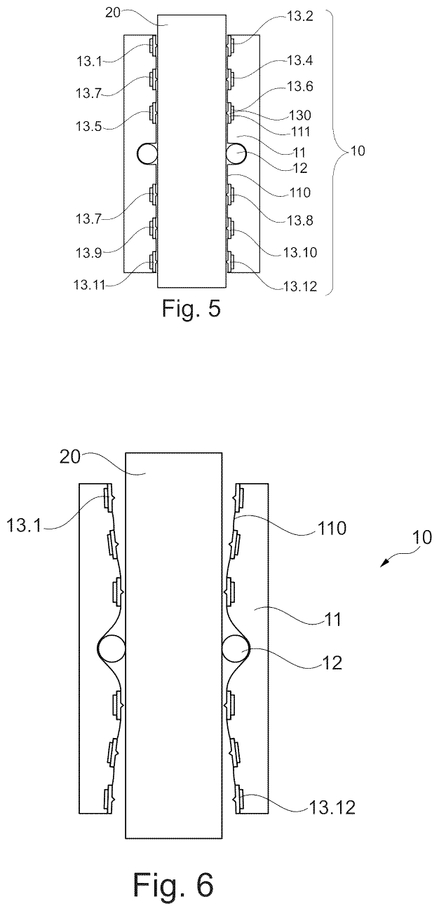

A guide bearing 10 of central axis X according to one example of the invention is shown in detail in FIG. 5.

It firstly comprises a ring 11 which is the component intended to be mounted tightly in the wall of the vessel R, the inner surface 110 of which is assembled with a clearance fit and makes it possible to guide the measurement rod 20 in translation along the axis X.

The guide bearing 10 also comprises an angulation element 12 configured to allow the rod 20 to take a plurality of angular positions relative to the central axis X of the bearing. This angulation element may be any mechanical element that allows swivelling as a minimum. For example, this angulation element may be an O ring, a ball bearing, a rolling bearing, or any other mechanical element known to a person skilled in the art and compatible with the invention.

According to the example illustrated, an O ring 12, preferably made of tough and smooth material, is fixed inside the inner surface 110 of the ring and protrudes into it, so as to form an angulation axis of the rod 20 relative to the axis X. In other words, the O ring 12 is a pivot bearing which makes it possible both to stabilize the relative movements between the measurement rod 20 and the ring 10 and to distribute on either side the pressure forces to which that part of the rod that is immersed in the fluid is subjected.

A plurality of pressure sensors 13.1 to 13.12 are received individually in cavities 111 in the inner surface 110 of the ring 11. Each of these sensors 13.1 to 13.12 comprises a protuberance 130 designed to be in contact with, and thus measure a value for the pressure exerted by the fluid on, a contact zone of the rod that brings about one of its angular positions.

The sensors 13.1 to 13.12 may be standard provided that they are precise and have a small space requirement. For example, the sensors sold by Wormsensing (https://www.wormsensing.com/) can be implemented both for rings of large size or smaller sizes, designed for measurement rods of small diameter.

As illustrated, the pressure sensors are preferably distributed in an equal number on either side of the O ring 12. This makes it possible to make the pressure measurements symmetrical, i.e. the measurements taken by the sensors 13.1, 13.3, 13.5 are made symmetrical with those of the sensors 13.8, 13.10, 13.12 and the measurements taken by the sensors 13.2, 13.4, 13.6 are made symmetrical with those of the sensors 13.7, 13.9, 13.11. With this symmetry of pressure measurements, it is possible to determine average or differential measurements.

In FIG. 5, the pressure sensors are all arranged along an inner surface 110 of the ring which is rectilinear, parallel to the axis X. This arrangement may be necessary in certain applications.

Advantageously, it is possible to envisage producing a profile of the inner surface 110 of the ring 11 that makes it possible to optimize the spatialization of pressure measurements and to develop, for each case of use of the fluid and its conditions in the vessel R, the law which links the position of each point of contact with a pressure sensor 13.1 to 13.12 and the angulation of the measurement rod 20.

To define the suitable profile, use can be made of a digital tool for generating surfaces which makes it possible to create the virtual profile. It is possible to use an interpolation tool for creating and describing polynomial and parametric curves (referred to as Bézier curves) with one or two dimensions (lines or surfaces) on the basis of several points and several parameters (angles, lengths, distances).

For a given diameter of measurement rod, it is possible to create dedicated profiles and an overall virtual surface can be generated as a function of the angulation ranges permitted for the measurement rod. The overall virtual surface can be made identical for different diameters, notably by means of an adapter; the overall virtual surface is then designed for the largest envisaged diameter.

Once the suitable profile has been defined, the ring 11 can be manufactured, in 2D and then rolled or in 3D by additive manufacturing, or by numerical control machining or the like. If an adaptation means has been provided, it may be manufactured separately and be removable or be part of the manufacture of the ring which will thus become dedicated to a given diameter.

Two variants can be envisaged for this optimization of the ring inner surface.

The first consists in producing an inner surface 110 such that during an angulation of the rod 20, the pressure sensors 13.1 to 13.12 come into contact with the rod 20 separately, one after another. This makes it possible to realize a subdivision of the pressure range which is established gradually.

The second consists in producing an inner surface 110 such that during an angulation of the rod 20, the pressure sensors 13.1 to 13.12 come into contact with the rod one after another, cumulating the pressure that they detect. This variant makes it possible to encourage widening of the pressure range that it is possible to measure, by progressively increasing a resistance to the pressure depending on forces that may become non-linear. This can be particularly suitable for certain uses.

One example of an optimized inner surface 110 is shown in FIG. 6. It can be seen that the profile of the inner surface 110 follows a defined curve on which the various sensors 13.1 to 13.12 are arranged.

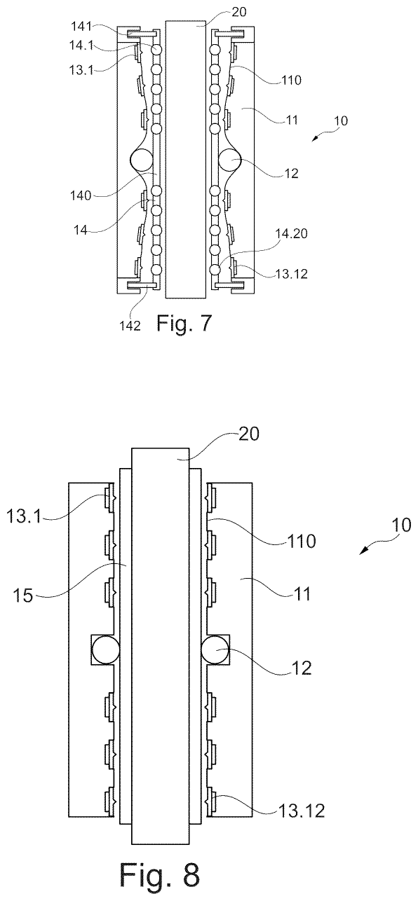

An advantageous embodiment of the guide bearing 10 is illustrated in FIG. 7.

A cylindrical ball-and-cage assembly 14 is shown while being held inside the ring 11. One portion 140, without balls, of the cage is in contact with the O ring 12. The ring 11 may be held by retaining rings 141, 142, arranged respectively at the top and at the bottom of the ring 11. These retaining rings limit the extent of oscillations orthogonal to the axis X. The translational or rotational movements of the rod are made possible or easier by the ball-and-cage assembly 14 without disrupting the measurements.

At least one portion of the balls 14.1 to 14.20 each forms the point of contact with a pressure sensor 13.1 to 13.12 arranged in the inner surface 110 of the ring.

It is possible to provide a number of balls corresponding to that of the sensors and arrange these balls such that each of them forms a point of contact of the rod with one of the pressure sensors. The balls can be calibrated with a single diameter.

As illustrated in this FIG. 7, alternatively, it is possible to provide that only one portion of the balls forms contact points. With the rotatability of the rod permitted by the ball-and-cage assembly, this makes it possible to create a rhythm or make the contacts with the pressure sensors random, and also to prolong the service life of the balls.

Other variants and improvements can be envisaged without departing from the scope of the invention.

A variant illustrated in FIG. 8 may consist in mounting a measurement rod 20 of smaller diameter in an adapter of diameter 15 which is itself in pivoting contact with the O ring 12 and is mounted with a clearance fit in the guide ring 10.

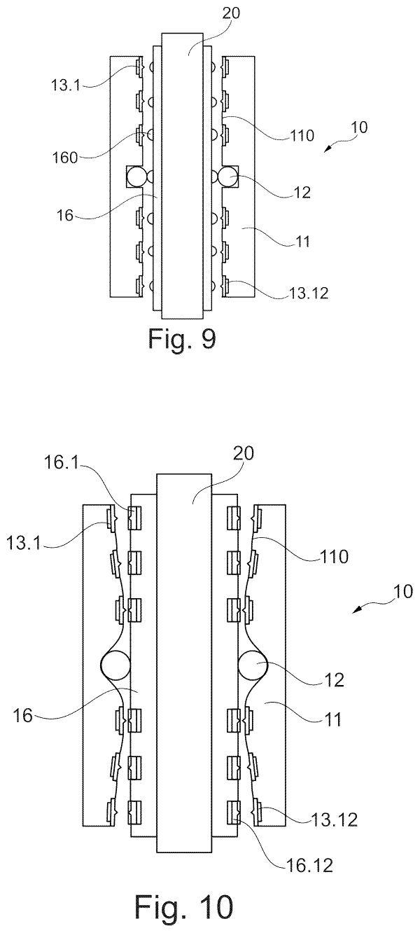

Another variant, illustrated in FIG. 9, may consist in mounting a measurement rod 20 of smaller diameter in a cylindrical sleeve 16 which is itself in pivoting contact with the O ring 12 and is mounted with a clearance fit in the guide ring 10. This sleeve 16 comprises protuberances each forming a point of contact with a pressure sensor 13.1 to 13.12 arranged in the inner surface 110 of the ring 11. The protuberances 160 may have different dimensions so as to create a surface profile of graduated pressure. This cylindrical sleeve 16 may be an adapter of diameter.

Another variant, illustrated in FIG. 10, may consist in mounting a measurement rod 20 of smaller diameter in another cylindrical sleeve 16 which is itself in pivoting contact with the O ring 12 and is mounted with a clearance fit in the guide ring 10. This sleeve 16 comprises pressure sensors 16.1 to 16.12 each forming a point of contact with a pressure sensor 13.1 to 13.12 arranged in the inner surface 110 of the ring 11. Provision can also be made to not equip the inner surface 110 of the ring 10 with pressure sensors, the pressure sensors 16.1 to 16.12 distributed inside the sleeve 16, along the inner surface 110 of the ring 12 then coming directly into contact with the latter. This cylindrical sleeve 16 may also be an adapter of diameter.

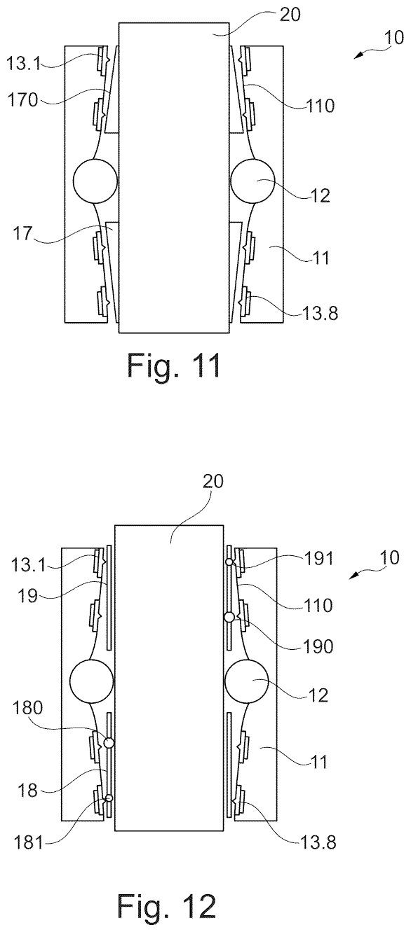

Another variant illustrated in FIG. 11 may consist in mounting a measurement rod 20 of smaller diameter in a sleeve 17 which is itself in pivoting contact with the O ring 12 and is mounted with a clearance fit in the guide ring 10. It is possible for the outer surface 170 of the sleeve 17 to not be cylindrical and to be produced according to a profile which contributes to developing the law for spatialization of the pressure range measured by the sensors 13.1 to 13.8. This non-cylindrical sleeve 17 may also be an adapter of diameter.

In the embodiment with a ball-and-cage assembly, instead of a single one-piece cage 14 mounted in the guide ring 10 as illustrated in FIG. 7, it is possible to envisage assembling two ball-and-cage assemblies arranged one on each side of the O ring with a space between them such that the latter is in pivoting contact directly with the measurement rod 20.

The variant illustrated in FIG. 12 shows such an embodiment with two cylindrical ball-and-cage assemblies 18, 19, one on each side of the O ring 12. In addition, it is possible to adapt the size of the balls depending on their position along the axis X. For example as illustrated, the balls of largest diameter 180, 190 may be those closest to the pivot bearing 12 and those of small diameter 181, 191 may be those positioned facing the ends of the ring 11.

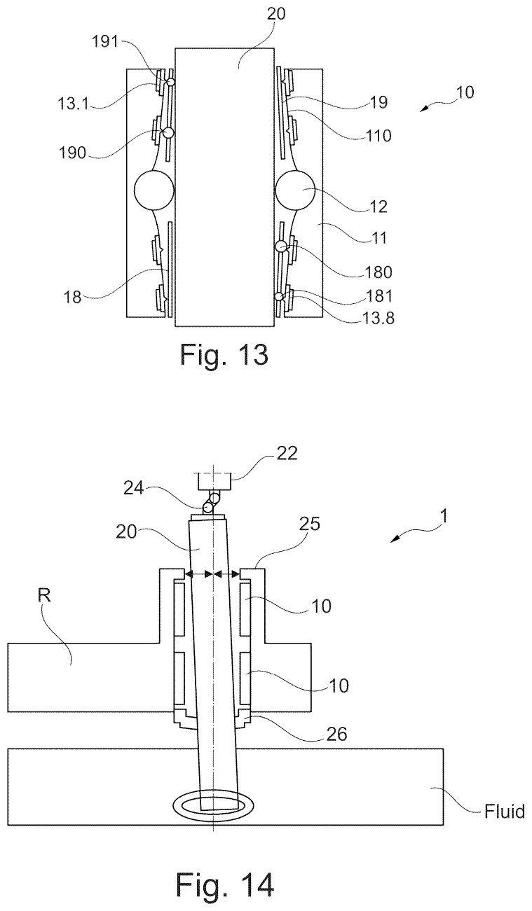

Instead of cylindrical ball-and-cage assemblies, it is possible to arrange conical ball-and-cage assemblies 18, 19, as shown in FIG. 13.

FIG. 14 illustrates an advantageous embodiment of the complete measuring system 1 for measuring the viscosity or the Reynolds number of a fluid contained in a vessel R.

A double gimbal connection 24 connects the upper end of the measurement rod 20.

To improve the guidance in translation along the axis X of the rod 20 and adjust the length of arrangement of the pressure sensors, two instrumented guide bearings 10 according to the invention are mounted tightly in the wall of the vessel, at a distance from one another. The guidance in translation is improved because the friction can be adjusted and/or eliminated.

It is also possible to provide an additional radial end stop 25 which limits the angular deflection of the rod 20. This radial end stop 25 may additionally have an anti-shock and/or anti-excessive wear function.

Lastly, at least one wiper seal 26 may be fixed to the wall of the vessel R and/or to the measurement rod so as to avoid any risk of pollution of the one or more instrumented guide bearings 10 by the medium within the vessel.

In the examples illustrated, the number of pressure sensors used is equal to 8 or 12, distributed in an equal number on either side of the angulation element (for example in the form of an O ring). It is possible of course to instrument the guide bearing with a lower or higher number depending on the pressure measurement spatialization desired.

1. A guide bearing of central axis, comprising:
a ring, intended to be mounted tightly in a holding structure, the inner surface of which is designed for assembling with a clearance fit, a tube intended to constitute a measurement rod;
an angulation element formed integrally or fixed inside the inner surface of the ring by protruding into it, so as to form an angulation axis of the tube relative to the central axis;
a plurality of pressure sensors each designed to measure a point of pressure exerted by a contact point of the tube in one of its angular positions, the pressure sensors being distributed along the inner surface of the ring, on either side of the angulation element.

2. The guide bearing according to claim 1, the angulation element being a mechanical element that allows swivelling.

3. The guide bearing according to claim 1, the angulation element being an O ring.

4. The guide bearing according to claim 1, the pressure sensors being distributed in an equal number on either side of the angulation element.

5. The guide bearing according to claim 1, the pressure sensors being received individually or in groups in cavities in the inner surface of the ring and each comprising a protuberance designed to be in contact with the contact point of the tube.

6. The guide bearing according to claim 1, the pressure sensors being aligned along one or more straight lines parallel to the central axis.

7. The guide bearing according to claim 1, the pressure sensors being arranged along a surface, such that during an angulation of the tube, the pressure sensors come into contact with the tube separately, one after another.

8. The guide bearing according to claim 1, the pressure sensors being arranged along a surface, such that during an angulation of the tube, the pressure sensors come into contact with the tube one after another, cumulating the pressure that they detect.

9. The guide bearing according to claim 1, there being four pressure sensors, coupled in pairs, for each diameter of the ring inner surface over which they are distributed.

10. The guide bearing according to claim 1, comprising at least one cylindrical or conical ball-and-cage assembly intended to hold the tube, the ball-and-cage assembly being mounted by being held inside the ring with a portion without balls in contact with the angulation element and at least one portion of the balls each forming the point of contact with a pressure sensor arranged in the inner surface of the ring.

11. The guide bearing according to claims 1, comprising at least one sleeve mounted by being held inside the ring, the sleeve comprising:
protuberances each forming the point of contact with a pressure sensor arranged in the inner surface of the ring, and/or
at least one portion of the pressure sensors distributed along its outer surface.

12. The guide bearing according to claim 1, the pressure sensors being piezoelectric sensors.

13. A system for measuring the viscosity or the Reynolds number of a fluid contained in a vessel, such as a tank, comprising:
at least one guide bearing according to claim 1, mounted tightly in a wall of the vessel,
a measurement rod which forms the tube, is assembled by way of a clearance fit in the ring of the guide bearing, and one, free end of which is intended to be immersed in the fluid,
at least one means for fixing the other end of the measurement rod, the means being designed to limit the angulation of the measurement rod in the ring.

14. The measuring system according to claim 13, comprising a sleeve forming an adapter of diameter in which the measurement rod is mounted tightly and which is assembled by way of a clearance fit with the ring.

15. The measuring system according to claim 14, the adapter of diameter comprising, on its outer surface, a plurality of protuberances each forming the point of contact with a pressure sensor arranged in the inner surface of the ring.

16. The measuring system according to claim 13, the electrochemical sensor being fixed at the free end of the measurement rod.

17. A settling or production tank, comprising a system according to claim 13.

18. Use of a measuring system according to claim 13 or of a bioreactor according to claim 17 for monitoring a bio-production.
